(19) United States
(12) Patent Application Publication
(10) Pub. No.: US 2015/0159023 A1
(43) Pub. Date: Jun. 11, 2015

(54) INTUMESCENT COATING COMPOSITION FOR COATING OF SHEET MATERIAL

(71) Applicants: Craig Lipka, Cresskill, NJ (US); John Philosophos, Chicago, IL (US); Roger Youngs, Hinsdale, IL (US)

(72) Inventors: Craig Lipka, Cresskill, NJ (US); John Philosophos, Chicago, IL (US); Roger Youngs, Hinsdale, IL (US)

(21) Appl. No.: 14/099,354

(22) Filed: Dec. 6, 2013

(51) Int. Cl. C09D 5/18; C08K 3/34; C08K 3/04

(52) U.S. Cl. CPC C09D 5/185; C08K 3/04; C08K 3/34

(57) ABSTRACT

A unique intumescent composition containing a high weight % solids content of approximately 58%, from a particular mix of solid ingredients including a mineral filler, ceramic fibers, a binder, an expandable graphite, and a solid thickener. The solids are mixed in approximately a 42% liquid carrier solution comprising water, a defoamer, and a dispersant. The resulting intumescent composition is an inert, inorganic, intumescent coating that can be coated or laminated onto paper, wood and/or OSB to act as a fire shield. The product also can also be coated onto steel, aluminum foil, kraft paper, fiberglass or any combination of the foregoing to provide a fire-shielding facer for manufactured insulation boards, sheetrock, polyisocyanurate boards, polystyrene boards, or other construction boards. The product provides excellent structural support to the resultant char after a fire in order to further protect the substrate from deterioration.

### CROSS-REFERENCE TO RELATED APPLICATION(S)

The present application derives priority from U.S. Provisional Patent Application 61/734,170 filed December 2012.

### BACKGROUND OF THE INVENTION

1. Field of the Invention

The present invention relates to intumescent fire protection coatings and, more specifically, an intumescent coating and process for forming of a fire retardant, non-volatile organic compound coating or laminate on sheet material such as paper, plywood, OSB or others for passive fire protection.

2. Description of the Background

Intumescent substances swell as a result of heat exposure, increasing in volume and decreasing in density. Owing to this property it is well-known employ intumescents for fire protection. Intumescent materials can expand from 10 to 20 times their original thickness when exposed to a fire. Conventional intumescent systems include a binder with urea-formaldehyde resins and melamine-formaldehyde resins, a char or carbon skeleton forming substance (typically referred to as “carbonific”), an expanding agent (typically referred to as “spumific”) and an acid forming substance as essential components. Typical examples of such compositions can be found in U.S. Pat. Nos. 4,442,157, 4,638,538, 3,562,197.

Intumescent compositions can be applied by any conventional method, e.g. spraying, dipping, drawing and brushing. However, conventional intumescent compositions have certain limitations, particularly on articles made of wood (including plywood, Oriented strand board (OSB), LVL, waferboard, particleboard and the like) due to the porosity and non-uniformity of the material. Conventional intumescent compositions have difficulty filling these voids, and the resulting uncoated voids or low-density coated areas allow fire and air to pass more freely. Fire spread is accelerated as a result of uncoated voids in the surface of the OSB panels, causing the panels to fail. This is a severe handicap due to the widespread use of such materials. OSB in particular was introduced by the Elmendorf Manufacturing Co. of Claremont, N.H., in 1982, and now dominates the national market for residential sheathing, accounting for 60% or more of the structural sheathing sold nationwide. OSB includes oriented strands of wood derived from naturally occurring hard or soft woods, cut into strands, wafers or particles, coated with a polymeric thermosetting binder resin and wax additive. Typically, the coating is sprayed upon the wood strands as the strands are tumbled in a drum blender. The blended mixture is formed into either a random mat or oriented multi-layered mats. The formed mats are pressed under a hot press machine which fuses and binds together the coated wood materials to form a consolidated OSB panel of desired thickness and size.

Intumescent, fire resistant compositions act by forming an expanded, insulating layer of a non-flammable material under the action of heat. Thus, in a fire this expanded layer of “char” shields the substrate from oxygen and/or from overheating and thereby prevents or delays the spread of flame, and prevents or at least delays reductions in the mechanical and static properties of structural supporting elements caused by heat. Given the mechanism, a greater expansion (intumescence) produces a thicker and more protective layer of char, but at the same time overexpansion can reduce the mechanical stability of the protective layer, and if the char collapses or erodes during the fire it may become entirely ineffective. What is needed is a high-solids intumescent coating composition material that exhibits a high expansion ratio and char strength, with reduced risk of collapse or erosion. At the same time the intumescent coating should be suitable for use on OSB and other porous wood-based sheet products, compensating for the porosity and non-uniformity of such materials (as stated above, conventional intumescent compositions are not well-suited for filling voids, cracks or seams, which remain open).

The present invention is a high-solids intumescent, fire resistant composition which is adept at filling voids and cracks in OSB, other wood-based sheet products despite the porosity and non-uniformity of such materials, and is suitable for other sheet products such as aluminum foil, paper, fiberglass, steel or the like. The present invention provides an optimal balance of high expansion ratio versus char strength when used on sheet products, so as to avoid collapse or abrasion of the char. The present composition decreases the FSR rating of the OSB panels, compliant with FM Approval Standard Class Number 4975, or ULC CAN4-S124M, UL 1715 (Room fire test). UBC 26-3, UBC 26-2, or ASTM E 84, and is better-suited for commercial structures.

### SUMMARY OF THE INVENTION

These and other objects are accomplished herein by an intumescent composition containing a high weight % solids content of approximately 58%, from a particular mix of solid ingredients including a mineral filler, ceramic fibers, a binder, an expandable graphite, and a solid thickener. The solids are mixed in approximately a 42% liquid carrier solution comprising water, a defoamer, and a dispersant. The resulting intumescent composition is an inert, inorganic, intumescent coating that can be coated or laminated onto paper, wood and/or OSB to act as a fire shield. The product can also be coated onto steel, aluminum foil, kraft paper, fiberglass or any combination of the foregoing to provide a fire-shielding facer for manufactured insulation boards, sheetrock, polyisocyanurate boards, polystyrene boards, or other construction boards. The intumescent composition is adept at filling voids and cracks in porous surfaces such as OSB and other wood-based sheet products, and strikes an optimal balance of high expansion ratio versus char strength. The product provides excellent structural support to the resultant char after a fire in order to further protect the substrate from deterioration.

Other objects, features, and advantages of the present invention will become more apparent from the following detailed description of the preferred embodiment and certain modifications thereof.

### DETAILED DESCRIPTION OF THE PREFERRED EMBODIMENTS

The present invention is an intumescent coating composition that can be coated or laminated onto paper, wood and/or OSB to act as a fire shield, or which can be coated onto steel, aluminum foil, kraft paper, fiberglass or any combination of the foregoing to provide a fire-shielding facer for manufactured insulation boards, sheetrock, polyisocyanurate boards, polystyrene boards, or other construction boards.

Generally, the intumescent coating composition combines a high solids content of approximately 58.2% weight percent (%)+/−5 weight % solid mixture including a mineral filler, ceramic fibers, a binder (in a liquid/solid mix), an expandable graphite, and a solid thickener. The solids are mixed in approximately a 41.8 weight %+/−5 weight % liquid carrier solution comprising a mixture of water, the binder, a defoamer, and a dispersant. The foregoing constituents are combined in preferred concentrations within acceptable ranges to provide a synergistic formulation that fills voids and cracks in porous surfaces, and provides a high intumescent expansion ratio with excellent char strength for structural support of the resultant char after a fire in order to further protect the coated substrate from deterioration. In an embodiment the foregoing constituents are combined in the following preferred weight percentages within acceptable ranges.

| | Preferred | Acceptable | | |
|---|---|---|---|---|
| Constituent | Weight % | Range | Solid? | Liquid? |
| Water | 26.2% | +/−5% | | Liquid |
| Mineral Filler | 14.0% | +/−3% | Solid | |
| Ceramic Fiber | 4.0% | +2% (no less | Solid | |
| | | than 4%) | | |
| Binder | 30.0% | +/−5% | 50% Solid | 50% Liquid |
| Expandable | 25.0% | +/−5% | Solid | |
| Graphite | | | | |
| Thickener | 0.2% | +/−.05% | Solid | |
| Defoamer | 0.1% | +/−.02% | | Liquid |
| Dispersant | 0.5% | +/−.1% | | Liquid |
| | 100.0% | | 58.2% | 41.8% |

The mineral filler is preferably standard talc in powder form, talc being a mineral comprised of hydrated magnesium silicate with the chemical formula H₂Mg₃(SiO₃)₄ or Mg₃Si₄O₁₀(OH)₂. Talc is commercially available often sold as talcum powder. As an alternative to Talc, other mineral fillers such as kaolin clay, other clay, calcium carbonate, or combinations thereof may also suffice. {{{{Char enhancer}}}}

The ceramic fiber is preferably a synthetic mineral ceramic fiber designed to add mechanical properties to paints and coatings. A presently-preferred fiber is commercially available under the trade designation COATFORCE™ (e.g., COATFORCE CF10) from Lapinus Fibres BV in Roermond, The Netherlands, which comprises SiO₂ (37-42% wt), Al₂O₃ (18-23% wt), CaO+MgO (34-39% wt), FeO (0-1% wt), and K₂O+Na₂O (3% wt). Other exemplary inorganic fibers include fiberglass, or fibers prepared from wollastonite (i.e., calcium silicate).

The binder is preferably a suitable latex binder comprising a water-borne dispersion of sub-micrometer polymer particles, such as used in latex paints. Such latex binder typically comprise approximately 50 wt % solid particles in a 50 wt % liquid dispersion. A presently preferred latex binder is Vycar® 660×14 PVC emulsion available from Lubrizol™. One skilled in the art should understand that other suitable latex binders incorporating acrylic, styrene butadyene, or PVC particles will also suffice.

The expandable graphite is a form of intercalated graphite, or graphite intercalation compound (GIC), such as is commercially available from Nyacol™ Corporation. Presently, Nyagraph™ 35 is preferred for its smaller average particle size and good expansion volume of 100 ml/g. One skilled in the art should understand that other suitable expandable graphites or “flake” graphites may also suffice.

The thickener is preferably a water-dispersible polymer thickener. One example is NATROSOL™ 250 HR (Aqualon Co., Wilmington, Del., USA), which is a hydroxyethyl cellulose. The thickener increases the viscosity of the compound without substantially modifying its other properties, and improves the suspension of the solid ingredients, thereby increasing the stability of the product. Other suitable thickeners include kelgin, modified starches, synthetic thickeners, or the like.

The defoamer (or anti-foaming agent) is a chemical additive that reduces and hinders the formation of foam by reducing entrained or entrapped air. A wide variety of chemical formulas are available to promote coalescence of foam. The presently preferred defoamer is Niaproof™ 675 (from Sigma Aldrich, St. Louis, Mo.).

The dispersant is a hyperdispersant used to improve particulate dispersion and to reduce interparticulate attraction within that dispersion. A variety of suitable dispersants are commercially available, such as amphoteric soy lecithin, and Aquasperse™ dispersant with A ethoxylated mono-diglycerides and propylene glycol (American Lecithin Company) is presently preferred. Suitable alternatives include sodium tripolyphosphate, or starch dispersants.

The foregoing solid ingredients are combined and mixed in solid form and then mixed with the liquid ingredients into a homogenous liquid suspension. The resulting viscosity is approximately 2400 cps+/−200 cps as measured using a Brookfield™ Viscometer with #3 spindle at 12 rpm. The intumescent coating composition may then be coated, laminated or sprayed onto substrate sheets such as OSB/plywood sheets, preferably in a single- or-multi-stage coating process. For example, a curtain coating process may be used in which the sheets are passed bottom-side up along a conveyor at a controlled speed under a continuous falling curtain of the coating, thereby receiving the coating on the surface. Assuming a standard size 2440×1220×16 mm OSB/plywood sheet, 35 grams of the coating composition may be uniformly applied to the surface of the OSB/plywood sheet. The bottom surface/bottom coat is then dried in ambient temperature until hard to the touch. A variety of commercially-available curtain coaters may be used at step 10 such as the Sorbini™ TM95 1E/1F curtain coater.

The high-solid intumescent, fire resistant composition described above is adept at filling voids and cracks in OSB, other wood-based sheet products despite the porosity and non-uniformity of such materials, and is suitable for other sheet products such as aluminum foil, paper, fiberglass, steel or the like. The present invention provides an optimal balance of high expansion ratio versus char strength when used on sheet products, so as to avoid collapse or abrasion of the char. The composition increases the fire safety rating (FSR) of OSB panels to be compliant with FM Approval Standard Class Number 4975, or ULC CAN4-S124M, UL 1715 (Room fire test), UBC 26-3, UBC 26-2, or AS™ E 84, and is better-suited for commercial structures.

Having now fully set forth the preferred embodiments and certain modifications of the concept underlying the present invention, various other embodiments as well as certain variations and modifications thereto may obviously occur to those skilled in the art upon becoming familiar with the underlying concept. For example, the sequence of steps may be altered such that the coating step precedes the notching of OSB/plywood boards. It is to be understood, therefore, that the invention may be practiced otherwise than as specifically set forth herein.

I claim:

1. An intumescent coating composition, comprising:
a first mixture comprising a solid content of approximately 58.2% weight percent (%)+/−5 weight % chosen from among a group consisting of a mineral filler, ceramic fibers, a binder, an expandable graphite, and a solid thickener; and
a second mixture comprising a liquid content of approximately 41.8 weight %+/−5 weight % chosen from among a group consisting of water, said binder, a defoamer, and a dispersant;
said first and second mixture being mixed together in a suspension.

2. The intumescent coating composition according to claim 1, wherein said first mixture consists of mineral filler, ceramic fibers, a binder, an expandable graphite, and a solid thickener.

3. The intumescent coating composition according to claim 1, wherein said second mixture consists of water, said binder, a defoamer, and a dispersant.

4. The intumescent coating composition according to claim 2, wherein said second mixture consists of water, said binder, a defoamer, and a dispersant.

5. The intumescent coating composition according to claim 1, comprising 26.2% of said water within an acceptable range of +/−5%.

6. The intumescent coating composition according to claim 1, comprising 14% of said mineral filler within an acceptable range of +/−3%.

7. The intumescent coating composition according to claim 1, comprising 4% of said ceramic fiber within an acceptable range of +2%.

8. The intumescent coating composition according to claim 7, comprising a minimum of 4% of said ceramic fiber.

9. The intumescent coating composition according to claim 1, comprising 30% of said binder within an acceptable range of +1-5%.

10. The intumescent coating composition according to claim 1, comprising 25% of said expandable graphite within an acceptable range of +1-5%.

11. The intumescent coating composition according to claim 1, comprising 0.2% of said thickener within an acceptable range of +/−0.5%.

12. The intumescent coating composition according to claim 1, comprising 0.1% of said defoamer within an acceptable range of +/−0.02%.

13. The intumescent coating composition according to claim 1, comprising 0.5% of said dispersant within an acceptable range of +/−0.1%.

14. The intumescent coating composition according to claim 1, comprising approximately:
26.2% of said water within an acceptable range of +1-5%;
14% of said mineral filler within an acceptable range of +/−3%;
4% of said ceramic fiber within an acceptable range of +2%;
at least 4% of said ceramic fiber;
30% of said binder within an acceptable range of +1-5%;
25% of said expandable graphite within an acceptable range of +1-5%;
0.2% of said thickener within an acceptable range of +/−0.5%.
0.1% of said defoamer within an acceptable range of +/−0.02%; and
0.5% of said dispersant within an acceptable range of +/−0.1%.

15. The intumescent coating composition according to claim 1, consisting essentially of:
26.2% of said water;
14% of said mineral filler;
4% of said ceramic fiber;
4% of said ceramic fiber;
30% of said binder;
25% of said expandable graphite;
0.2% of said thickener;
0.1% of said defoamer; and
0.5% of said dispersant.

16. An intumescent coating composition, comprising:
water;
mineral filler;
ceramic fiber;
binder;
expandable graphite;
thickener;
defoamer;
dispersant.

17. The intumescent coating composition according to claim 16, comprising 26.2% of said water within an acceptable range of +/−5%.

18. The intumescent coating composition according to claim 16, comprising 14% of said mineral filler within an acceptable range of +/−3%.

19. The intumescent coating composition according to claim 16, comprising 4% of said ceramic fiber within an acceptable range of +2%.

20. The intumescent coating composition according to claim 19, comprising a minimum of 4% of said ceramic fiber.

21. The intumescent coating composition according to claim 16, comprising 30% of said binder within an acceptable range of +1-5%.

22. The intumescent coating composition according to claim 16, comprising 25% of said expandable graphite within an acceptable range of +1-5%.

23. The intumescent coating composition according to claim 16, comprising 0.2% of said thickener within an acceptable range of +/−0.5%.

24. The intumescent coating composition according to claim 16, comprising 0.1% of said defoamer within an acceptable range of +/−0.02%.

25. The intumescent coating composition according to claim 16, comprising 0.5% of said dispersant within an acceptable range of +/−0.1%.

26. The intumescent coating composition according to claim 16, comprising approximately:
26.2% of said water within an acceptable range of +1-5%;
14% of said mineral filler within an acceptable range of +/−3%;
4% of said ceramic fiber within an acceptable range of +2%;
at least 4% of said ceramic fiber;
30% of said binder within an acceptable range of +1-5%;
25% of said expandable graphite within an acceptable range of +1-5%;
0.2% of said thickener within an acceptable range of +/−0.5%.
0.1% of said defoamer within an acceptable range of +/−0.02%; and
0.5% of said dispersant within an acceptable range of +/−0.1%.

27. The intumescent coating composition according to claim 16, consisting essentially of:
26.2% of said water;
14% of said mineral filler;
4% of said ceramic fiber;
4% of said ceramic fiber;
30% of said binder;
25% of said expandable graphite;
0.2% of said thickener;
0.1% of said defoamer; and
0.5% of said dispersant.

28. The intumescent coating composition according to claim 27, wherein said mineral filler is one of H₂Mg₃(SiO₃)₄ or Mg₃Si₄O₁₀(OH)₂.

29. The intumescent coating composition according to claim 28, wherein said ceramic fiber comprises SiO₂ within a range of from 37-42% wt, Al₂O₃ within a range of from 18-23% wt, CaO+MgO within a range of from 34-39% wt, FeO within a range of from 0-1% wt, and K₂O+Na₂O within a range of from 3% wt.

30. The intumescent coating composition according to claim 27, having a viscosity of approximately 2400 cps+/−200 cps.

31. An intumescent coating composition consisting of 26.2% water, 14% talc, 4% ceramic fiber, 30% latex binder, 25% graphite intercalation compound (GIC), 0.2% water-dispersible polymer thickener, 0.1% defoamer, and 0.5% dispersant, the foregoing ingredients being mixed in a homogenous liquid suspension having a viscosity of 2400 cps+/−200 cps.
